(19) United States
(12) Patent Application Publication
(10) Pub. No.: US 2017/0367422 A1
(43) Pub. Date: Dec. 28, 2017

(54) SKULLCAP WITH FULL SIZE IMAGE AND METHOD OF MAKING THE SAME

(71) Applicants: URI TURK, Brooklyn, NY (US); SU CHEN, Guangzhou (CN)

(72) Inventors: URI TURK, Brooklyn, NY (US); SU CHEN, Guangzhou (CN)

(73) Assignee: Pic-A-Kippa LLC, Brooklyn, NY (US)

(21) Appl. No.: 15/391,748

(22) Filed: Dec. 27, 2016

Related U.S. Application Data
(60) Provisional application No. 62/354,095, filed on Jun. 23, 2016.

(51) Int. Cl. A42B 1/04; B41J 2/01; A42C 1/00; G06T 3/00; A42B 1/00

(52) U.S. Cl. CPC A42B 1/041; G06T 3/0093; A42B 1/004; A42C 1/00; B41J 2/01

(57) ABSTRACT

A method comprising steps: (a) providing an image; (b) opening the image in a photo editing software program; (c) importing a skullcap shape having four equal triangular curve portions into the photo editing software program; (d) editing the image to match the skullcap shape and triangular curve portions; (e) printing the edited image to a medium; (f) separating the four triangular curve portions of the printed image; and (g) sewing the four separate triangular curve portions into a skullcap.

### CROSS-REFERENCE TO RELATED APPLICATIONS

This application claims benefit to U.S. Provisional Application Ser. No. 62/354,095 entitled “Skullcap with Image and Method of Making the Same”, filed Jun. 23, 2016 herein incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### Field of the Invention

The present invention relates to skullcaps. More particularly, the present invention relates a skullcap with full size image and method of making the same.

### Background of the Invention

Jewish law requires men to cover their heads as a sign of respect and reverence during prayer. In some Judaism movements the skullcap is required to worn at all times. The Hebrew word for skullcap is a kippah, which translates to dome. Other names the skullcap may be referred to include kippa, kipoh, kip, koppel, kippot, or yarmulke.

Currently, there are limited designs and options available for skullcaps. A consumer is limited to colors, materials, various patterns, and embroideries on a quarter of the skullcap. Consequently, there is a need for a skullcap that would be more appealing to the wearer, by allowing a full image on the skullcap.

### BRIEF SUMMARY OF THE INVENTION

In one embodiment of the present invention a skullcap is provided, comprising a first triangle curve portion having a first image section; a second triangle curve portion having a second image section; a third triangle curve portion having a third image section; a fourth triangle curve portion having a fourth image section; wherein the first, second, third, and fourth triangle cure portions are sewed together and the corresponding first, second, third, and fourth image sections form a complete image expanding the entirety of the skullcap.

In another aspect of the present invention a method is provided, comprising steps: (a) providing an image; (b) opening the image in a photo editing software program; (c) importing a skullcap shape having four equal triangular curve portions into the photo editing software program; (d) editing the image to match the skullcap shape and triangular curve portions; (e) printing the edited image to a medium; (f) separating the four triangular curve portions of the printed image; and (g) sewing the four separate triangular curve portions into a skullcap.

In one embodiment, in step (e), the printing is performed on a hot transfer inkjet printer at a printing temperature of over 100 degrees Celsius. In another embodiment, the medium is a fabric. In one embodiment, in step (f), the four triangular curve portions are separated via a cutting method.

### BRIEF DESCRIPTION OF THE SEVERAL VIEWS OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1A is an exemplary top perspective view illustrating a skullcap with image according to an embodiment of the present invention.

FIG. 1B is an exemplary top view showing the skullcap with image of FIG. 1A.

FIG. 2 is an exemplary method of making a skullcap with an image according to an embodiment of the present invention.

FIG. 3 is an exemplary architectural diagram of an Internet computer network system according to an embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

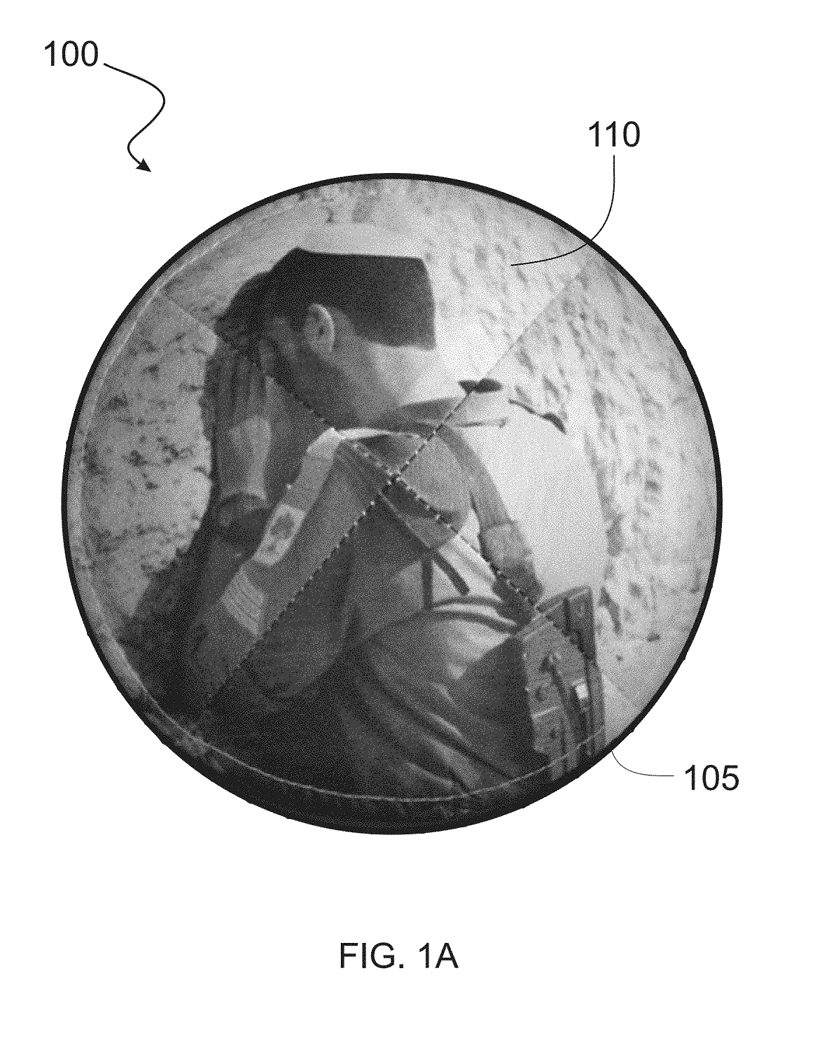

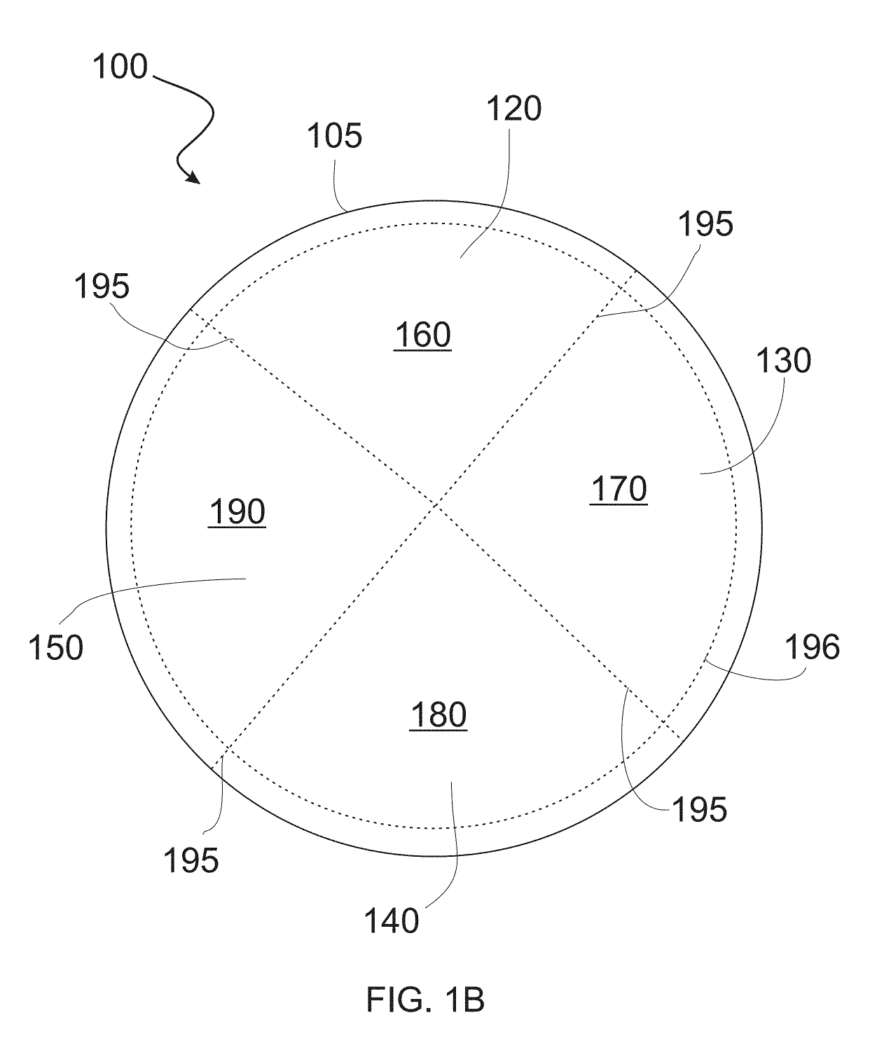

FIG. 1A is an exemplary top perspective view illustrating a skullcap with image 100 according to an embodiment of the present invention. The skullcap having a dome shape comprises an image 110, wherein the image is the entirety of the skullcap. The skullcap has a rounded base 105 with fabric sewed in a dome shape. The skullcap is a kippah, kippa, kipoh, kip, koppel, kippot, or yarmulke and the shape is well known in the art. The method of making the skullcap will be described in greater detail below. The image illustrated in FIG. 1A is for exemplary purposes, showing that the image occupies the entirety of the skullcap. The actual image may vary, and the image may be selected by the consumer from a list of available images. In some embodiments, the images represent Judaism giving the wearer a sense of Jewish pride; however it is understood that any image may be used. For instance, in the instant example, the image is of a Golani soldier at the Western Wall in the act of praying. In some embodiments, a consumer may upload an image to be made into a skullcap on a consumer website, or choose from a number of options. For instance, the image may be related to sports, nature, countries, states, cities, universities, pop culture, or any image the consumer desires.

FIG. 1B is an exemplary top view showing the skullcap with image of FIG. 1A. Skullcap 100 comprises four triangles curve portions 120, 130, 140, and 150. Each triangle curve portion represents a section of the full image; as triangle curve portions 120, 130, 140, 150 correspond to image sections 160, 170, 180, and 190 respectively. When the image sections are combined and sewed 195 in the correct order, they form a complete full image, as illustrated in FIG. 1A. The triangle curve portions are of equal size, but the overall size may vary. The skullcap may have a diameter of 5.7 inches or 6.2 inches. These are typical sized skullcaps as well known in the art, but it is understood that the size may vary without departing from the scope of the invention. A reinforcement thread may be sewed in a circle shape 196 proximal to the base of the skullcap, further securing the four triangle curve portions together.

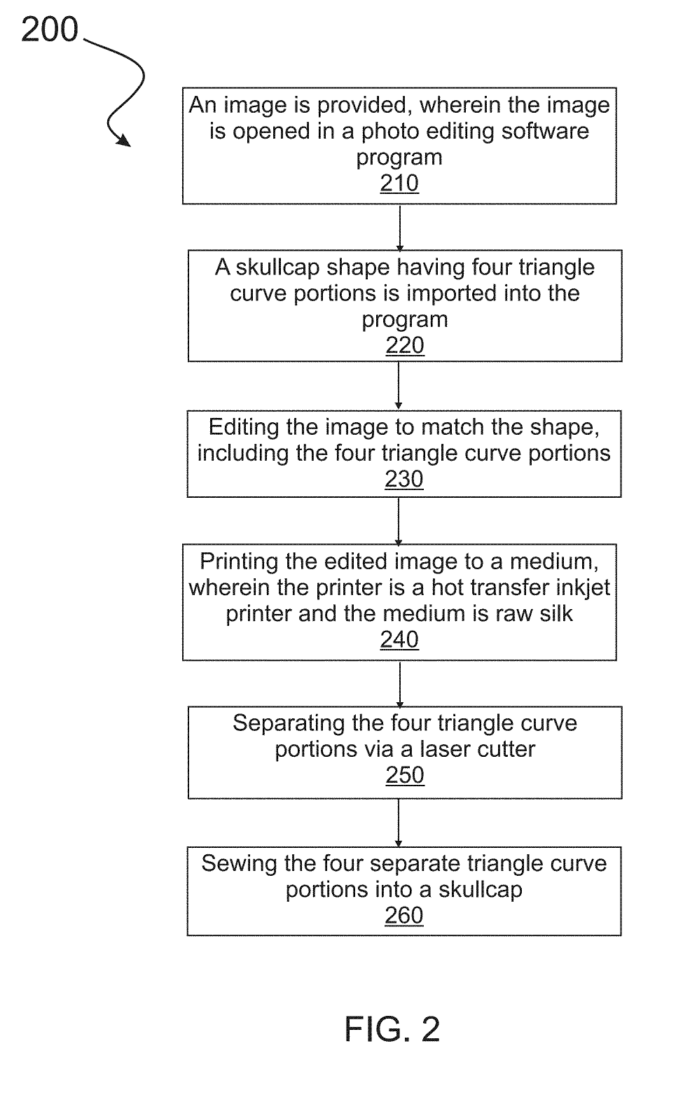

FIG. 2 is an exemplary method 200 of making a skullcap with an image according to an embodiment of the present invention. In step 210, an image is provided, wherein the image is opened in a photo editing software program. In one embodiment, the photo editing software program is Adobe Photoshop, but other photo editing software programs may be used. In step 220, a skullcap shape having four triangle curve potions is imported into the photo editing software program. In step 230, the image is edited to match the skullcap shape, including the four triangle curve portions. The four triangle curve portions are illustrated in FIG. 1B. In this step, the image likely starts as a rectangular or square image and is edited into a skullcap or dome shape. It is critical that the image is edited to match the dome shape or spherical shape, rather than a rounded flat image. The specific details of the editing process are well known in the art of photo editing and design, such as using the Adobe Photoshop curve layer tool to warp the image into a spherical dome shape. This step further includes resizing the image to match the skullcap shape including the four triangle curve portions. The actual size of the skull cap can be selected during printing which will be described in further detail below.

In step 240, the edited image is printed to a medium, wherein the printer is a hot transfer inkjet printer and the medium is a fabric. In some embodiments, any fabric may be used including but not limited to, raw silk, synthetic suede, cotton, polyester, or mesh. The temperature of the hot transfer printing is over 100 degrees Celsius. In some embodiment, the printing temperature may vary. The printed image may be printed to the desired size of the skullcap as previously mentioned. In step 250, the four triangle curve portions are separated via a cutting method. In one embodiment, the separation is done using a laser cutter. In alternative embodiment, the cutting is done by hand using scissors. Last, in step 260, the four separate triangle curve portions are sewed into a skullcap. The skullcap is now ready for use.

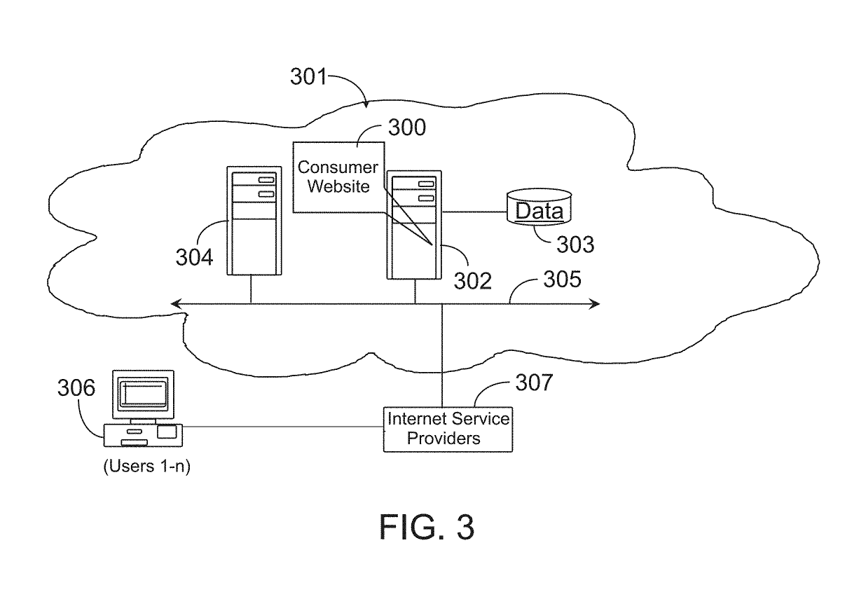

FIG. 3 is an exemplary architectural diagram of an Internet 301 computer network system according to an embodiment of the present invention. The Internet-connected system comprises one or more Internet-connected servers 302 executing the consumer website 300 from non-transitory media. Server 302 is connected to a data repository 303, which may be any sort of data storage known in the art. The system further comprises a third party Internet-connected server 304 connected to Internet backbone 305. Although one third party Internet-connected server 304 is shown, it is understood that potentially millions of other similar servers are connected to the Internet via Internet backbone 305. A number of users (1-n) 306 are connected to the Internet-connected server via an Internet service provider (ISP) 307, allowing users 306 to access the consumer website.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although a skullcap having four equal triangle curve portions are disclosed, any number of triangle curve portions may be included such as six triangle curve portions or more.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A skullcap comprising:
a first triangle curve portion having a first image section;
a second triangle curve portion having a second image section;
a third triangle curve portion having a third image section;
a fourth triangle curve portion having a fourth image section;
wherein the first, second, third, and fourth triangle cure portions are sewed together and the corresponding first, second, third, and fourth image sections form a complete image occupying the entirety of the skullcap.

2. A method comprising steps:
(a) providing an image;
(b) opening the image in a photo editing software program;
(c) importing a skullcap shape having four equal triangular curve portions into the photo editing software program;
(d) editing the image to match the skullcap shape and triangular curve portions;
(e) printing the edited image to a medium;
(f) separating the four triangular curve portions of the printed image; and
(g) sewing the four separate triangular curve portions into a skullcap.

3. The method of claim 3, wherein in step (e), the printing is performed on a hot transfer inkjet printer at a printing temperature of over 100 degrees Celsius.

4. The method of claim 4, wherein the medium is a fabric.

5. The method of claim 3, wherein in step (f), the four triangular curve portions are separated via a cutting method.
